(19) United States
(12) Patent Application Publication
(10) Pub. No.: US 2026/0268370 A1
(43) Pub. Date: Sep. 10, 2026

(54) METHOD, APPARATUS, MEDIUM, ELECTRONIC DEVICE, AND PROGRAM PRODUCT FOR DETERMINING PROMOTER

(71) Applicant: Beijing Youzhuju Network Technology Co., Ltd., Beijing (CN)

(72) Inventors: Tao Xiao, Beijing (CN); Yahui Lei, Beijing (CN); Wenbin Lu, Beijing (CN); Yinsong Xue, Beijing (CN)

(21) Appl. No.: 19/535,282

(22) Filed: Feb. 10, 2026

(30) Foreign Application Priority Data
Mar. 6, 2025 (CN) 202510265825.4

(51) Int. Cl. G06Q 30/0251; G06N 3/09

(52) U.S. Cl. CPC G06Q 30/0254; G06N 3/09

(57) ABSTRACT

A method and an apparatus for determining a promoter, a medium, an electronic device, and a program product, which relate to the technical field of the Internet. The method includes: obtaining, from a pre-trained graph model, a first vector corresponding to a target deliverer and a second vector corresponding to each of at least one candidate promoter, where the graph model is generated based on historical interaction records between every two of at least one deliverer, the at least one candidate promoter, and at least one user, and is used to describe each deliverer, each candidate promoter, and each user through a vector, and the at least one deliverer includes the target deliverer; determining a similarity between each second vector and the first vector corresponding to the target deliverer; and determining a target promoter of the target deliverer from the plurality of candidate promoters based on the similarity.

### CROSS-REFERENCE TO RELATED APPLICATION(S)

This application claims priority to Chinese Application No. 202510265825.4 filed on Mar. 6, 2025, the disclosure of which is incorporated herein by reference in its entirety.

### FIELD

The present disclosure relates to the technical field of the Internet, and specifically, to a method, an apparatus, a medium, an electronic device, and a program product for determining a promoter.

### BACKGROUND

With the development of the Internet, the Internet has become a main channel for a deliverer to promote information, for example, promote advertisements.

### SUMMARY

The Summary section is provided to briefly introduce concepts, which will be described in detail in the following Detailed Description section. The Summary section is not intended to identify key features or essential features of the claimed technical solutions, nor is it intended to limit the scope of the claimed technical solutions.

In the first aspect, the present disclosure provides a method for determining a promoter, including:
obtaining, from a pre-trained graph model, a first vector corresponding to a target deliverer and a second vector corresponding to each of at least one candidate promoter, where the graph model is generated based on historical interaction records between every two of at least one deliverer, the at least one candidate promoter, and at least one user, and is used to describe each deliverer, each candidate promoter, and each user through a vector, and the at least one deliverer includes the target deliverer;
determining a similarity between each second vector and the first vector corresponding to the target deliverer; and
determining a target promoter of the target deliverer from the plurality of candidate promoters based on the similarity.

In the second aspect, the present disclosure provides an apparatus for determining a promoter, including:
an obtaining module configured to obtain, from a pre-trained graph model, a first vector corresponding to a target deliverer and a second vector corresponding to each of at least one candidate promoter, where the graph model is generated based on historical interaction records between every two of at least one deliverer, the at least one candidate promoter, and at least one user, and is used to describe each deliverer, each candidate promoter, and each user through a vector, and the at least one deliverer includes the target deliverer;
a first determination module configured to determine a similarity between each second vector and the first vector corresponding to the target deliverer; and
a second determination module configured to determine a target promoter of the target deliverer from the plurality of candidate promoters based on the similarity.

In the third aspect, the present disclosure provides a computer-readable medium having a computer program stored thereon, where, when the computer program is executed by a processing apparatus, the steps of the method according to the first aspect are implemented.

In the fourth aspect, the present disclosure provides an electronic device, including:
a storage apparatus having a computer program stored thereon; and
a processing apparatus configured to execute the computer program in the storage apparatus to implement the steps of the method according to the first aspect.

In the fifth aspect, the present disclosure provides a computer program product including a computer program, where when the computer program is executed by a processor, the steps of the method according to the first aspect are implemented.

### BRIEF DESCRIPTION OF THE DRAWINGS

The above and other features, advantages, and aspects of the embodiments of the present disclosure will become more apparent in combination with the drawings and with reference to the following specific implementations. Throughout the drawings, the same or similar reference numerals represent the same or similar elements. It should be understood that the drawings are schematic, and parts and elements are not necessarily drawn to scale. In the drawings:

FIG. 1 is a schematic diagram of an application scenario according to an embodiment of the present disclosure;

FIG. 2 is a flowchart of a method for determining a promoter according to an embodiment of the present disclosure;

FIG. 3 is a schematic diagram of a graph network according to an embodiment of the present disclosure;

FIG. 4 is a block diagram of an apparatus for determining a promoter according to an embodiment of the present disclosure; and

FIG. 5 is a schematic diagram of a structure of an electronic device according to an embodiment of the present disclosure.

### DETAILED DESCRIPTION OF EMBODIMENTS

Embodiments of the present disclosure will be described in more detail below with reference to the drawings. Although some embodiments of the present disclosure are shown in the drawings, it should be understood that the present disclosure may be implemented in various forms, and should not be interpreted as being limited to the embodiments set forth herein. Instead, these embodiments are provided for a more thorough and complete understanding of the present disclosure. It should be understood that the drawings and embodiments of the present disclosure are only for exemplary purposes, and are not intended to limit the protection scope of the present disclosure.

It should be understood that steps described in method implementations of the present disclosure may be performed in different orders, and/or performed in parallel. In addition, the method implementations may include additional steps and/or omit performing illustrated steps. The scope of the present disclosure is not limited in this regard.

The term “include/comprise” and its variants used herein are open-ended inclusions, that is, “include/comprise but not limited to”. The term “based on” is “at least partially based on”. The term “one embodiment” means “at least one embodiment”. The term “another embodiment” means “at least one another embodiment”. The term “some embodiments” means “at least some embodiments”. Relevant definitions of other terms will be given in the following description.

It should be noted that concepts such as “first” and “second” mentioned in the present disclosure are only used to distinguish different apparatuses, modules, or units, and are not used to limit an order or interdependence of functions performed by these apparatuses, modules, or units.

It should be noted that modifications of “one” and “a plurality of” mentioned in the present disclosure are schematic rather than restrictive. Those skilled in the art should understand that unless otherwise clearly specified in the context, they should be understood as “one or more”.

Names of messages or information exchanged between a plurality of apparatuses in the implementations of the present disclosure are only used for illustrative purposes, and are not used to limit the scope of these messages or information.

It may be understood that before using the technical solutions disclosed in the embodiments of the present disclosure, the user should be informed of the type, range of use, use scenarios, etc., of personal information involved in the present disclosure, and the authorization of the user should be obtained in an appropriate manner in accordance with relevant laws and regulations.

For example, in response to receiving an active request from a user, prompt information is sent to the user to clearly prompt the user that the requested operation will require access to and use of personal information of the user. In this way, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select whether to “agree” or “disagree” to provide the personal information to the electronic device.

It may be understood that the above process of notifying and obtaining user authorization is only schematic, and does not limit the implementations of the present disclosure. Other manners that satisfy relevant laws and regulations may also be applied to the implementations of the present disclosure.

Meanwhile, it may be understood that the data involved in the technical solution (including but not limited to the data itself, acquisition or use of the data) shall comply with requirements of corresponding laws, regulations, and related provisions.

In related technologies, a deliverer generally uses an account provided by a promoter with a certain influence to promote information. With the development of the Internet, the number of promoters with a certain influence is increasing. Therefore, how to select the best promoter for a deliverer from a large number of promoters is an urgent technical issue that needs to be solved.

In related technologies, a promoter is recommended to a deliverer by matching industries, for example, matching content that has been posted by a promoter and content that a deliverer wants to deliver, and recommending, to the deliverer, a promoter that has posted content similar to the content that the deliverer wants to deliver. However, in this way, the deliverer will not be extended to promoters in other industries, and even if a promoter in the same industry is recommended to the deliverer, it is not easy to distinguish the differences between the promoters.

In view of this, embodiments of the present disclosure provide a method, an apparatus, a medium, an electronic device, and a program product for determining a promoter. The present disclosure will be further explained and described below with reference to the drawings.

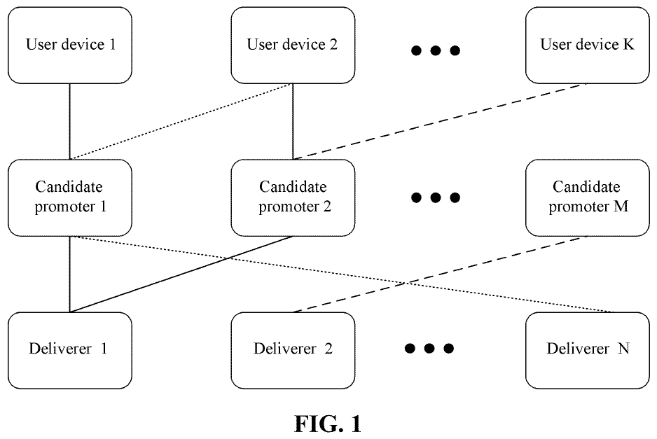

FIG. 1 is a schematic diagram of an application scenario according to an embodiment of the present disclosure. In FIGS. 1, N, M, and K are all positive integers greater than or equal to 3. In FIG. 1, a deliverer 1, a deliverer 2, . . . , and a deliverer N may be different merchants, and push information (for example, products of the merchants) to users corresponding to user devices 1, user devices 2, . . . , and user devices K through a candidate promoter 1, a candidate promoter 2, . . . , and a candidate promoter M, respectively. For example, an electronic device may be configured to determine, based on a pre-trained graph model, through which candidate promoters a target deliverer (for example, the deliverer 1) pushes information to the user devices. The electronic device may be, for example, a hardware device such as a computer, a tablet, or a smartphone, or may be, for example, an application running on a hardware device, or may be, for example, a merchant client or a server of an e-commerce platform, which is not limited in this implementation scenario.

In this embodiment, the attention paid to the candidate promoter is greater than preset attention. The candidate promoter usually focuses on content creation, live streaming, or social media interaction to promote information. Taking a product as an example, the candidate promoter may create content related to the product, and post the content to the Internet that may reach the user corresponding to the user device. As an example, the created content may be a video, an article, or the like.

In this embodiment, the attention paid to the candidate promoter may be determined based on the number of users who follow an account provided by the promoter for promoting information. For example, if the number of users who follow the account is greater than or equal to a preset number, it represents that the attention paid to the account is greater than the preset attention; and if the number of users who follow the account is less than the preset number, it represents that the attention paid to the account is greater than the preset attention. Further, the preset number may be set based on the actual situation, which is not limited to this embodiment.

In the implementation scenario shown in FIG. 1, the electronic device may be implemented based on a pre-trained graph model. For the training of the graph model, reference may be made to the following related embodiments, which will not be repeated in this embodiment.

In the following embodiments, for ease of description and understanding, the candidate promoter may be referred to as an influencer, and the deliverer may be referred to as a merchant.

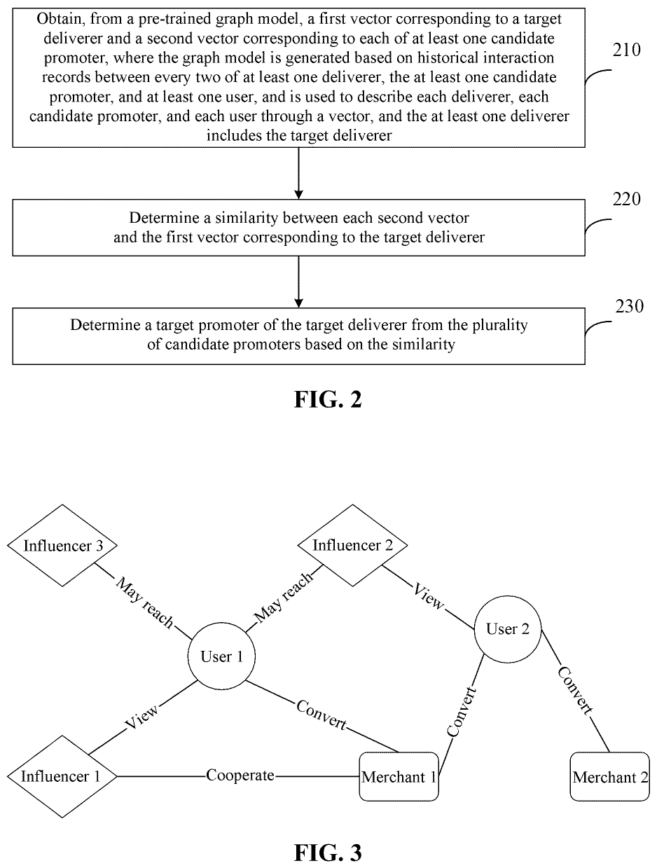

FIG. 2 is a flowchart of a method for determining a promoter according to an embodiment of the present disclosure. The method for determining a promoter may be applied to an electronic device, and the method for determining a promoter may be performed by an apparatus for determining a promoter. The apparatus for determining a promoter may be implemented in software and/or hardware, and the software and/or hardware may be configured in, for example, the electronic device described above. Referring to FIG. 2, the method for determining a promoter may include step 210, step 220, and step 230.

In step 210, a first vector corresponding to a target deliverer and a second vector corresponding to each of at least one candidate promoter are obtained from a pre-trained graph model, and the graph model is generated based on historical interaction records between every two of at least one deliverer, the at least one candidate promoter, and at least one user, and is used to describe each deliverer, each candidate promoter, and each user through a vector, and the at least one deliverer includes the target deliverer;

In step 220, a similarity between each second vector and the first vector corresponding to the target deliverer is determined; and

In step 230, a target promoter of the target deliverer is determined from the plurality of candidate promoters based on the similarity.

Through the above technical solution, the first vector corresponding to the target deliverer and the second vector corresponding to each of the at least one candidate promoter is obtained from the pre-trained graph model. The similarity between each second vector and the first vector corresponding to the target deliverer is determined. The target promoter of the target deliverer is determined from the plurality of candidate promoters based on the similarity. Since the graph model may fully excavate the similarity between the deliverer, the candidate promoter, and the user, the best promoter may be accurately selected for the deliverer based on the graph model, thereby improving the effectiveness of information promotion.

In some embodiments, the historical interaction records may include interaction records between each said candidate promoter and each said user, cooperation records between each said candidate promoter and each said deliverer, and conversion records between each said deliverer and each said user.

For example, if the user has a conversion behavior (for example, a purchase behavior) for a product of the deliverer, a corresponding conversion record may be generated. For another example, if there is a cooperation behavior between the candidate promoter and the deliverer, a corresponding cooperation record may be generated. For another example, if the user views the information posted by the candidate promoter, a corresponding viewing record may be generated.

In some embodiments, the similarity may be cosine similarity. A cosine value of an included angle between two vectors in a vector space may be used as a measure of a difference between the two vectors, that is, a measure of the similarity. For example, the cosine value (similarity) between the first vector Vm corresponding to the target deliverer m and the second vector Vj corresponding to the candidate promoter j may be determined by the following equation (1):

$$cos ( m , j ) = \frac{Vm * Vj}{‖ Vm ‖ ‖ Vj ‖} \qquad ( 1 )$$

In the above equation (1), cos(m,j) is the cosine value between the first vector Vm and the second vector Vj, ∥Vm∥ is a norm of the first vector Vm, and ∥Vj∥ is a norm of the second vector Vj.

In some embodiments, step 230 may be implemented in the following manner: sorting all similarities in a descending order to obtain a sorting result; and taking candidate promoters corresponding to top preset similarities in the sorting result as the target promoter.

The preset position may be set based on the actual situation, which is not limited in this embodiment.

In some embodiments, the graph model may be trained in the following manners: obtaining historical interaction records between every two of at least one deliverer, at least one candidate promoter, and at least one user; establishing a graph network based on the historical interaction records, where the graph network includes a plurality of nodes, the nodes are used to represent deliverers, candidate promoters, or users, and in the graph network, a connection edge connecting any two nodes is used to represent that there is an interaction record between the two nodes in the historical interaction records, or to represent that it is predicted, based on the historical interaction records, that the two nodes may generate an interaction record in the future; and training a graph neural network model based on the graph network to obtain the graph model.

In this embodiment, for the historical interaction records, reference may be made to the above related embodiments, which will not be repeated in this embodiment.

FIG. 3 is a schematic diagram of a graph network according to an embodiment of the present disclosure. Referring to FIG. 3, the nodes in the graph network represent merchants, users, or influencers.

In the graph network, the connection edge connecting any two nodes is used to represent that there is an interaction record between the two nodes in the historical interaction records. For example, referring to FIG. 3, if there is a cooperation record between the influencer 1 and the merchant 1 in the historical interaction records, a node corresponding to the influencer 1 and a node corresponding to the merchant 1 may be connected. For another example, still referring to FIG. 3, if there is a conversion record between the user 1 and the merchant 1 in the historical interaction records, that is, the user 1 purchased a product of the merchant 1, a node corresponding to the user 1 and the node corresponding to the merchant 1 may be connected. For another example, still referring to FIG. 3, if the user 1 viewed content posted by the influencer 1 and purchased the product corresponding to the content in the historical interaction records, the node corresponding to the user 1 and the node corresponding to the influencer 1 may be connected.

In the graph network, the connection edge connecting any two nodes may also be used to represent that it is predicted, based on the historical interaction records, that the two nodes may generate an interaction record in the future. For example, referring to FIG. 3, in the case where the user 1 browsed the content posted by the influencer 1 and purchased the product corresponding to the content, it is assumed that the influencer 2 and the influencer 3 also posted content of the product, it may be predicted that the content posted by the influencer 2 and the influencer 3 may also reach the user 1, that is, it is predicted that the user 1 may see the content posted by the influencer 2 and the influencer 3, and thus the node corresponding to the user 1 and a node corresponding to the influencer 2 may be connected, and the node corresponding to the user 1 and a node corresponding to the influencer 3 may be connected.

In this embodiment, for the training of the graph model, reference may be made to the following related embodiments, which will not be repeated in this embodiment.

Through the above manner, the two nodes corresponding to the interaction record are directly connected through the interaction record recorded in the historical interaction record. In addition, reasonable prediction may also be performed based on the interaction record in the historical interaction record, and a connection edge is constructed for the two nodes that are predicted to be able to generate an interaction record in the future. In this way, the data volume of the graph network may be increased, thereby improving the generalization of the graph model obtained through training based on the graph network.

In some embodiments, the step of training the graph neural network model based on the graph network to obtain the graph model may include the following steps: generating a node sequence based on the graph network; extracting a positive sample and a negative sample from the node sequence; and iterating a loss function of the graph neural network model based on the positive sample and the negative sample to obtain the graph model.

In this embodiment, the node sequence may be generated based on a random walk. Specifically, the random walk is performed on the graph network multiple times. Starting from each node, an adjacent node is randomly selected for transition, and several steps are repeated to obtain the node sequence. On this basis, a positive sample and a negative sample corresponding to a target node are generated for the target node in the node sequence. The loss function of the graph neural network model is iterated based on the positive sample and the negative sample corresponding to the target node to obtain the graph model.

The length of the node sequence may be set based on the actual situation, which will not be repeated in this embodiment.

The positive sample and the negative sample of the target node may be determined through a window size, and the window size represents the maximum number of nodes in a window. As an example, for the node sequence [A, B, C, D, E, F, and G], taking the window size of 2 as an example, if the target node is the node A, the node B may be used as a positive sample of the node A, and the node C, the node D, the node E, the node F, and the node G may be used as negative samples of the node A. If the target node is node B, node A and node C may be used as positive samples of node B, and node D, node E, node F, and the node G may be used as negative samples of the node B.

The loss function includes similarity loss of the positive sample and dissimilarity loss of the negative sample. As an example, the loss function may be represented by the following equation (2):

$$loss = - {\sum }_{i = 1}^{q} log σ ( μ * {v}_{pos}^{i} ) - {\sum }_{c = 1}^{p} log σ ( μ * {v}_{neg}^{c} ) \qquad ( 2 )$$

In the above equation (2), loss is a loss value, q is the number of positive sample nodes of the target node, p is the number of negative sample nodes of the target node, log is a logarithmic function, σ is a Sigmoid function, the Sigmoid function is used to map a dot product to a probability value, μ is a vector representation of the target node,

$${v}_{pos}^{i}$$

is a vector representation of an ith positive sample node of the target node, and

$${v}_{neg}^{c}$$

is a vector representation of a cth negative sample node of the target node.

The vector representation of the node may be updated through back propagation of the loss function, so that the vector representations that are positive samples of each other are closer, and the vector representations that are negative samples of each other are farther away.

The stop condition for the iteration may be that the number of iterations reaches a preset number of iterations, a descending gradient of the loss function is less than a preset gradient value, etc., which is not limited in this embodiment.

In some embodiments, the connection edge is given a weight, which may be used in the training of the graph model. In this case, the step of training the graph neural network model based on the graph network to obtain the graph model may include the following steps: generating a node sequence based on the graph network and at least the weight, where in the process of generating the node sequence, when determining a next node of a current node in the node sequence, a node with a larger weight among nodes having a connection edge with the current node has a greater probability of being determined as the next node; generating a positive sample and a negative sample corresponding to a target node in the node sequence; and iterating a loss function of the graph neural network model based on the positive sample and the negative sample corresponding to the target node to obtain the graph model.

The weight may represent an association strength between the nodes. In the method of generating the node sequence by using random walk, the weight of the edge may affect the walking process. For example, an edge with a larger weight is more likely to be selected in the random walk process, that is, it means that the nodes connected by the edge with the larger weight are more likely to appear together in the node sequence. For example, still referring to the graph network shown in FIG. 3, if the weight of the connection edge between the influencer 1 and the user 1 is 1, the weight of the connection edge between the influencer 2 and the user 1 is 2, the weight of the connection edge between the influencer 3 and the user 1 is 3, and the weight of the connection edge between the user 1 and the merchant 1 is 4, when the user 1 is the current node, the probability that the merchant 1 is used as the next node of the user 1 is the greatest.

For the determination of the positive sample and the negative sample and the loss function, reference may be made to the above related embodiments, which will not be repeated in this embodiment.

Through the above manner, the influence of the weight of the edge between the nodes on the vector representation of the learning node is considered, and the weight is applied to the training of the model to improve the accuracy of the vector representation learned by the model.

In some embodiments, the weight of the connection edge may also be used to adjust contributions of the positive sample and the negative sample in the loss function. For example, a larger weight may be given to a node pair with a larger weight of the connection edge to ensure that the vector representations of these nodes may be closer during the learning process of the model. This may be implemented by introducing a weight representing the contribution degree into the loss function.

In some embodiments, when generating the positive sample and the negative sample, the weight of the connection edge may be used to adjust the sample distribution. For example, a node pair with a larger weight of the connection edge may be preferentially selected as a positive sample, while a node pair with a smaller weight of the connection edge may be used as a negative sample. This helps the model better learn the similarity and dissimilarity between the nodes.

In some embodiments, when generating the node sequence, a change rule of node types in the node sequence may also be controlled. For example, it is required that two adjacent nodes in the node sequence have different types. For another example, in consecutive nodes, the order of the node types is fixed. It should be noted that in the graph network, the user, the merchant, and the influencer correspond to three different types of nodes, respectively. In this way, the generation manner of the node sequence may be determined based on actual needs.

In some embodiments, in the case that the connection edge between the two nodes is used to represent that there is an interaction record between the two nodes in the historical interaction records, the weight of the connection edge between the two nodes is positively correlated with the number of interactions between the two nodes.

It should be noted that since the weight will be used for the training of the graph model, the greater the number of interactions, the stronger the correlation and relevance between the nodes. Therefore, the weight of the connection edge between the two nodes being positively correlated with the number of interactions between the two nodes, helps the model better learn the similarity and dissimilarity between the nodes.

In some embodiments, in the case where the connection edge between the two nodes is used to represent that it is predicted, based on the historical interaction records, that the two nodes may generate an interaction record in the future, the weight of the connection edge between the two nodes is determined through a prediction probability, and the prediction probability is used to represent a probability that the two nodes may generate an interaction record in the future.

In this embodiment, the prediction probability may be the reach probability. In the two nodes having the connection edge, taking a node corresponding to an influencer and a node corresponding to a user as an example, the reach probability is used to represent the probability that content promoted by the influencer may reach the corresponding user.

In some embodiments, the prediction probability corresponding to the two nodes may be determined in the following manners: obtaining interaction data between the two nodes within preset time; and determining the prediction probability corresponding to the two nodes by using a pre-trained probability prediction model based on the interaction data.

The preset time may be selected based on the actual situation, which is not limited to this embodiment.

In this embodiment, in the two nodes having the connection edge, taking a node corresponding to an influencer and a node corresponding to a user as an example, the interaction data may be the number of times of playing of content promoted by the influencer on the user device corresponding to the user, the playing duration of the content promoted by the influencer on the user device corresponding to the user, the number of likes given by the user to the content promoted by the influencer, the number of comments made by the user on the content promoted by the influencer, whether the user shared the content promoted by the influencer, whether the user added the content promoted by the influencer to favorites, and the number of times the user clicked on a home page of the influencer through the user device, etc.

The pre-trained probability prediction model may be a decision tree, a random forest, and an xgboost, etc. The model may be trained based on historical interaction data to obtain the probability prediction model. On this basis, the prediction probability corresponding to the two nodes is predicted by using the pre-trained probability prediction model based on the interaction data.

Through the above manner, the determination of the prediction probability is implemented.

In some embodiments, when the graph network is constructed, in the case where the prediction probability between the two nodes is greater than or equal to a preset probability threshold, the connection edge between the two nodes is constructed; and in the case that the prediction probability between the two nodes is less than the preset probability threshold, the construction of the connection edge between the two nodes is prohibited. The preset probability threshold is selected based on the actual situation, which is not limited to this embodiment.

Since the correlation between the nodes is higher when the prediction probability is sufficiently large, the distance between such nodes should be closer when the model learns the vector representation based on the graph network, and the distance between the nodes corresponding to a smaller prediction probability should be farther. Therefore, the connection edge between the two nodes is constructed only when the probability that the content promoted by the influencer may reach the corresponding user is sufficiently large, to provide an accurate data basis for the model training.

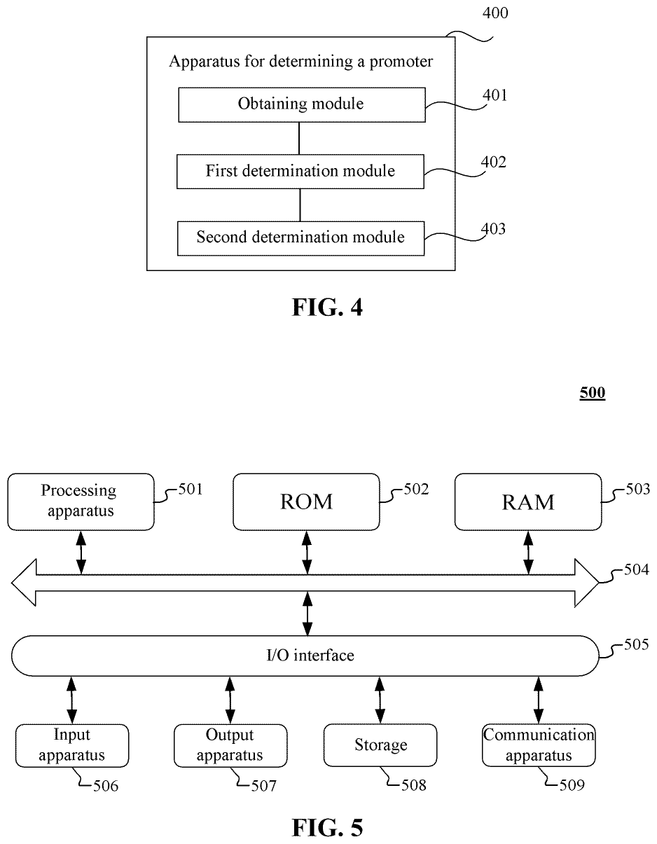

FIG. 4 is a block diagram of an apparatus for determining a promoter according to an embodiment of the present disclosure. Referring to FIG. 4, the apparatus 400 for determining a promoter may include:
an obtaining module 401 configured to obtain, from a pre-trained graph model, a first vector corresponding to a target deliverer and a second vector corresponding to each of at least one candidate promoter, where the graph model is generated based on historical interaction records between every two of at least one deliverer, the at least one candidate promoter, and at least one user, and is used to describe each deliverer, each candidate promoter, and each user through a vector, and the at least one deliverer includes the target deliverer;
a first determination module 402 configured to determine a similarity between each second vector and the first vector corresponding to the target deliverer; and
a second determination module 403 configured to determine a target promoter of the target deliverer from the plurality of candidate promoters based on the similarity.

Optionally, the apparatus 400 further includes a training module, and the training module includes:
a first obtaining sub-module configured to obtain the historical interaction records between every two of the at least one deliverer, the at least one candidate promoter, and the at least one user;
an establishing sub-module configured to establish a graph network based on the historical interaction records, where the graph network includes a plurality of nodes, the nodes are used to represent the deliverers, the candidate promoters, or the users, and in the graph network, a connection edge connecting any two nodes is used to represent that there is an interaction record between the two nodes in the historical interaction records, or to represent that it is predicted, based on the historical interaction records, that the two nodes may generate an interaction record in the future; and
a training sub-module configured to train a graph neural network model based on the graph network to obtain the graph model.

Optionally, the connection edge is given a weight, and the training sub-module is further configured to:
generate a node sequence based on the graph network and at least the weight, where in the process of generating the node sequence, when determining the next node of a current node in the node sequence, a node with a larger weight among nodes having the connection edge with the current node has a greater probability of being determined as the next node;
generate a positive sample and a negative sample corresponding to a target node in the node sequence; and
iterate a loss function of the graph neural network model based on the positive sample and the negative sample corresponding to the target node to obtain the graph model.

Optionally, in the case that the connection edge between the two nodes is used to represent that there is an interaction record between the two nodes in the historical interaction records, the weight of the connection edge between the two nodes is positively correlated with the number of interactions between the two nodes.

Optionally, in the case that the connection edge between the two nodes is used to represent that it is predicted, based on the historical interaction records, that the two nodes may generate an interaction record in the future, the weight of the connection edge between the two nodes is determined through a prediction probability, and the prediction probability is used to represent a probability that the two nodes may generate an interaction record in the future.

Optionally, the apparatus 400 further includes a third determination module, and the third determination module includes:
a second obtaining sub-module configured to obtain interaction data between the two nodes within preset time; and
a first determination sub-module configured to determine the prediction probability corresponding to the two nodes by using a pre-trained probability prediction model based on the interaction data.

Optionally, the attention paid to the candidate promoter is greater than preset attention.

For the implementations of each module of the apparatus 400 for determining a promoter, reference may be made to the above related embodiments, which will not be repeated in this embodiment.

An embodiment of the present disclosure further provides a computer-readable medium having a computer program stored thereon, where when the computer program is executed by a processing apparatus, the steps of the above method for determining a promoter are implemented.

An embodiment of the present disclosure further provides a computer program product including a computer program, when the computer program is executed by a processor, the steps of the above method for determining a promoter are implemented.

An embodiment of the present disclosure further provides an electronic device, including:
a storage apparatus having a computer program stored thereon; and
a processing apparatus configured to execute the computer program in the storage apparatus to implement the steps of the above method for determining a promoter.

Reference is made to FIG. 5 below, which illustrates a schematic structural diagram of an electronic device 500 suitable for implementing an embodiment of the present disclosure. The terminal device in the embodiment of the present disclosure may include, but is not limited to, a mobile terminal such as a mobile phone, a notebook computer, a digital broadcast receiver, a personal digital assistant (PDA), a tablet computer, a portable media player (PMP), and a vehicle-mounted terminal (for example, a vehicle navigation terminal), and a fixed terminal such as a digital TV and a desktop computer. The electronic device shown in FIG. 5 is only an example, and should not impose any limitation on the function and scope of use of the embodiment of the present disclosure.

As shown in FIG. 5, the electronic device 500 may include a processing apparatus (e.g., a central processing unit, a graphics processor, etc.) 501 that may perform various appropriate actions and processing according to a program stored in a read-only memory (ROM) 502 or a program loaded from a storage apparatus 508 into a random-access memory (RAM) 503. The RAM 503 further stores various programs and data required for operations of the electronic device 500. The processing apparatus 501, the ROM 502, and the RAM 503 are interconnected by means of a bus 504. An input/output (I/O) interface 505 is also connected to the bus 504.

Usually, the following apparatuses may be connected to the I/O interface 505: an input apparatus 506 including, for example, a touch screen, a touchpad, a keyboard, a mouse, a camera, a microphone, an accelerometer, and a gyroscope; an output apparatus 507 including, for example, a liquid crystal display (LCD), a speaker, and a vibrator; the storage apparatus 508 including, for example, a magnetic tape and a hard disk; and a communication apparatus 509. The communication apparatus 509 may allow the electronic device 500 to communicate with other devices in a wireless manner or in a wired manner for data exchange. Although FIG. 5 shows the electronic device 500 with various apparatuses, it should be understood that not all the apparatuses shown herein need to be implemented or provided. Alternatively, more or fewer apparatuses may be implemented or provided.

In particular, according to the embodiment of the present disclosure, the process described above with reference to the flowchart may be implemented as a computer software program. For example, the embodiment of the present disclosure includes a computer program product including a computer program carried on a non-transitory computer-readable medium, where the computer program includes program code for performing the method shown in the flowchart. In such an embodiment, the computer program may be downloaded online and installed through the communication apparatus 509, or installed from the storage apparatus 508, or installed from the ROM 502. When the computer program is executed by the processing apparatus 501, the functions defined in the method of the embodiment of the present disclosure are executed.

It should be noted that the computer-readable medium in the present disclosure may be a computer-readable signal medium, a computer-readable storage medium, or any combination of the two. The computer-readable storage medium may be, for example, but is not limited to, an electrical, magnetic, optical, electromagnetic, infrared, or semiconductor system, apparatus, or device, or any suitable combination of the above. More specific examples of the computer-readable storage medium may include, but are not limited to, an electrical connection having one or more wires, a portable computer magnetic disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, where the program may be used by or in combination with an instruction execution system, apparatus, or device. In the present disclosure, the computer-readable signal medium may include a data signal propagated on a baseband or as a part of a carrier wave, and computer-readable program code is carried in the data signal. The data signal propagated in this manner may be in multiple forms, including, but not limited to, an electromagnetic signal, an optical signal, or any suitable combination of the above. The computer-readable signal medium may also be any computer-readable medium other than the computer-readable storage medium, and the computer-readable signal medium may send, propagate, or transmit the program used by or in combination with the instruction execution system, apparatus, or device. The program code contained on the computer-readable medium may be transmitted in any suitable medium, including, but not limited to, a wire, an optical cable, a radio frequency (RF), or any suitable combination of the above.

In some implementations, the electronic device may communicate using any currently known or future developed network protocol, such as the hypertext transfer protocol (HTTP), and may be interconnected with any form or medium of digital data communication (for example, a communication network). Examples of the communication network include a local area network (“LAN”), a wide area network (“WAN”), an internet (for example, the Internet), a peer-to-peer network (for example, an Ad-Hoc network), and any network currently known or to be developed in the future.

The computer-readable medium may be contained in the electronic device, or may exist alone without being assembled into the electronic device.

The computer-readable medium carries one or more programs, and when the one or more programs are executed by the electronic device, the electronic device: obtains, from a pre-trained graph model, a first vector corresponding to a target deliverer and a second vector corresponding to each of at least one candidate promoter, where the graph model is generated based on historical interaction records between every two of at least one deliverer, the at least one candidate promoter, and at least one user, and is used to describe each deliverer, each candidate promoter, and each user through a vector, and the at least one deliverer includes the target deliverer; determines a similarity between each second vector and the first vector corresponding to the target deliverer; and determines a target promoter of the target deliverer from the plurality of candidate promoters based on the similarity.

The computer program code for performing the operations of the present disclosure may be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or server. In the case of involving the remote computer, the remote computer may be connected to the user computer through any kind of network, including a local area network (LAN) or a wide area network (WAN), or may be connected to an external computer (for example, connected through the Internet using an Internet service provider).

The flowcharts and block diagrams in the drawings illustrate the possibly implemented architectures, functions, and operations of the system, the method, and the computer program product according to various embodiments of the present disclosure. In this regard, each block in the flowchart or block diagram may represent a module, program segment, or part of code, which contains one or more executable instructions for implementing the specified logical functions. It should also be noted that, in some alternative implementations, the functions marked in the blocks may also occur in an order different from that marked in the drawings. For example, two blocks shown in succession may actually be executed substantially in parallel, or they may sometimes be executed in the reverse order, depending on the functions involved. It should also be noted that each block in the block diagram and/or the flowchart, and a combination of the blocks in the block diagram and/or the flowchart may be implemented in a dedicated hardware-based system that executes specified functions or operations, or may be implemented in a combination of dedicated hardware and computer instructions.

The modules involved in the embodiments of the present disclosure may be implemented in software or hardware. The name of a module does not constitute a limitation on the module itself under certain circumstances.

The functions described above herein may be performed at least in part by one or more hardware logic components. For example, without limitation, exemplary types of hardware logic components that may be used include: field programmable gate array (FPGA), application specific integrated circuit (ASIC), application specific standard product (ASSP), system on chip (SOC), complex programmable logic device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination of the above. More specific examples of the machine-readable storage medium may include an electrical connection based on one or more wires, a portable computer magnetic disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above.

The above description is only preferred embodiments of the present disclosure and an explanation of technical principles employed. Those skilled in the art should understand that the scope of disclosure involved in the present disclosure is not limited to the technical solutions formed by the specific combination of above technical features, and should also cover other technical solutions formed by any combination of the above technical features or their equivalent features without departing from the above disclosed concept. For example, the above features and the technical features provided in the present disclosure (but not limited to) with similar functions are replaced each other to form a technical solution.

In addition, although operations are depicted in a specific order, this should not be understood as requiring these operations to be performed in the specific order shown or in a sequential order. Under certain circumstances, multitasking and parallel processing may be advantageous. Similarly, although several specific implementation details are included in the above discussion, these should not be interpreted as limiting the scope of the present disclosure. Certain features described in the context of separate embodiments may also be implemented in combination in a single embodiment. Conversely, various features described in the context of a single embodiment may also be implemented in multiple embodiments individually or in any suitable sub-combination.

Although the subject matter has been described in a language specific to structural features and/or logical actions of the method, it should be understood that the subject matter defined in the appended claims is not necessarily limited to the specific features or actions described above. Conversely, the specific features and actions described above are only exemplary forms of implementing the claims. Regarding the apparatuses in the above embodiments, the specific manner in which each module performs an operation has been described in detail in the embodiments relating to the method, and will not be detailed herein.

I/We claim:

1. A method for determining a promoter, comprising:
obtaining, from a pre-trained graph model, a first vector corresponding to a target deliverer and a second vector corresponding to each of at least one candidate promoter, wherein the graph model is generated based on historical interaction records between every two of at least one deliverer, the at least one candidate promoter, and at least one user, and is used to describe each deliverer, each candidate promoter, and each user through a vector, and the at least one deliverer comprises the target deliverer;
determining a similarity between each second vector and the first vector corresponding to the target deliverer; and
determining a target promoter of the target deliverer from the plurality of candidate promoters based on the similarity.

2. The method of claim 1, wherein the graph model is trained by:
obtaining the historical interaction records between every two of the at least one deliverer, the at least one candidate promoter, and the at least one user;
establishing a graph network based on the historical interaction records, wherein the graph network comprises a plurality of nodes, the nodes are used to represent the deliverers, the candidate promoters, or the users, and in the graph network, a connection edge connecting any two nodes is used to represent that there is an interaction record between the two nodes in the historical interaction records, or to represent that it is predicted, based on the historical interaction records, that the two nodes are able to generate an interaction record in the future; and
training a graph neural network model based on the graph network to obtain the graph model.

3. The method of claim 2, wherein the connection edge is given a weight, and training a graph neural network model based on the graph network to obtain the graph model comprises:
generating a node sequence based on the graph network and at least the weight, wherein in the process of generating the node sequence, in response to determining a next node of a current node in the node sequence, a node with a larger weight among nodes having the connection edge with the current node has a greater probability of being determined as the next node;
generating a positive sample and a negative sample corresponding to a target node in the node sequence; and
iterating a loss function of the graph neural network model based on the positive sample and the negative sample corresponding to the target node to obtain the graph model.

4. The method of claim 3, wherein in a case that the connection edge between the two nodes is used to represent that there is an interaction record between the two nodes in the historical interaction records, a weight of the connection edge between the two nodes is positively correlated with a number of interactions between the two nodes.

5. The method of claim 3, wherein in a case that the connection edge between the two nodes is used to represent that it is predicted, based on the historical interaction records, that the two nodes are able to generate an interaction record in the future, a weight of the connection edge between the two nodes is determined through a prediction probability, and the prediction probability is used to represent a probability that the two nodes may generate an interaction record in the future.

6. The method of claim 5, wherein the prediction probability corresponding to the two nodes is determined by:
obtaining interaction data between the two nodes within preset time; and
determining the prediction probability corresponding to the two nodes by using a pre-trained probability prediction model based on the interaction data.

7. The method of claim 1, wherein attention paid to the candidate promoter is greater than preset attention.

8. A non-transitory computer-readable medium having instructions stored thereon, wherein the instructions, when executed by a processing device, cause the device to:
obtain, from a pre-trained graph model, a first vector corresponding to a target deliverer and a second vector corresponding to each of at least one candidate promoter, wherein the graph model is generated based on historical interaction records between every two of at least one deliverer, the at least one candidate promoter, and at least one user, and is used to describe each deliverer, each candidate promoter, and each user through a vector, and the at least one deliverer comprises the target deliverer;
determine a similarity between each second vector and the first vector corresponding to the target deliverer; and
determine a target promoter of the target deliverer from the plurality of candidate promoters based on the similarity.

9. The medium of claim 8, wherein the instructions causing the device to train the graph model comprise instructions causing the device to:
obtain the historical interaction records between every two of the at least one deliverer, the at least one candidate promoter, and the at least one user;
establish a graph network based on the historical interaction records, wherein the graph network comprises a plurality of nodes, the nodes are used to represent the deliverers, the candidate promoters, or the users, and in the graph network, a connection edge connecting any two nodes is used to represent that there is an interaction record between the two nodes in the historical interaction records, or to represent that it is predicted, based on the historical interaction records, that the two nodes are able to generate an interaction record in the future; and
train a graph neural network model based on the graph network to obtain the graph model.

10. The medium of claim 9, wherein the connection edge is given a weight, and the instructions causing the device to train a graph neural network model based on the graph network to obtain the graph model comprise instructions causing the device to:
generate a node sequence based on the graph network and at least the weight, wherein in the process of generating the node sequence, in response to determining a next node of a current node in the node sequence, a node with a larger weight among nodes having the connection edge with the current node has a greater probability of being determined as the next node;
generate a positive sample and a negative sample corresponding to a target node in the node sequence; and
iterate a loss function of the graph neural network model based on the positive sample and the negative sample corresponding to the target node to obtain the graph model.

11. The medium of claim 10, wherein in a case that the connection edge between the two nodes is used to represent that there is an interaction record between the two nodes in the historical interaction records, a weight of the connection edge between the two nodes is positively correlated with a number of interactions between the two nodes.

12. The medium of claim 10, wherein in a case that the connection edge between the two nodes is used to represent that it is predicted, based on the historical interaction records, that the two nodes are able to generate an interaction record in the future, a weight of the connection edge between the two nodes is determined through a prediction probability, and the prediction probability is used to represent a probability that the two nodes may generate an interaction record in the future.

13. The medium of claim 10, wherein the prediction probability corresponding to the two nodes is determined by instructions causing the device to:
obtain interaction data between the two nodes within preset time; and
determine the prediction probability corresponding to the two nodes by using a pre-trained probability prediction model based on the interaction data.

14. The medium of claim 8, wherein attention paid to the candidate promoter is greater than preset attention.

15. An electronic device, comprising:
a storage having instructions stored thereon; and
a processing device configured to execute the instructions in the storage to:
obtain, from a pre-trained graph model, a first vector corresponding to a target deliverer and a second vector corresponding to each of at least one candidate promoter, wherein the graph model is generated based on historical interaction records between every two of at least one deliverer, the at least one candidate promoter, and at least one user, and is used to describe each deliverer, each candidate promoter, and each user through a vector, and the at least one deliverer comprises the target deliverer;
determine a similarity between each second vector and the first vector corresponding to the target deliverer; and
determine a target promoter of the target deliverer from the plurality of candidate promoters based on the similarity.

16. The device of claim 15, wherein the instructions causing the device to train the graph model comprise instructions causing the device to:
obtain the historical interaction records between every two of the at least one deliverer, the at least one candidate promoter, and the at least one user;
establish a graph network based on the historical interaction records, wherein the graph network comprises a plurality of nodes, the nodes are used to represent the deliverers, the candidate promoters, or the users, and in the graph network, a connection edge connecting any two nodes is used to represent that there is an interaction record between the two nodes in the historical interaction records, or to represent that it is predicted, based on the historical interaction records, that the two nodes are able to generate an interaction record in the future; and
train a graph neural network model based on the graph network to obtain the graph model.

17. The device of claim 16, wherein the connection edge is given a weight, and the instructions causing the device to train a graph neural network model based on the graph network to obtain the graph model comprise instructions causing the device to:
generate a node sequence based on the graph network and at least the weight, wherein in the process of generating the node sequence, in response to determining a next node of a current node in the node sequence, a node with a larger weight among nodes having the connection edge with the current node has a greater probability of being determined as the next node;
generate a positive sample and a negative sample corresponding to a target node in the node sequence; and
iterate a loss function of the graph neural network model based on the positive sample and the negative sample corresponding to the target node to obtain the graph model.

18. The device of claim 17, wherein in a case that the connection edge between the two nodes is used to represent that there is an interaction record between the two nodes in the historical interaction records, a weight of the connection edge between the two nodes is positively correlated with a number of interactions between the two nodes.

19. The device of claim 18, wherein in a case that the connection edge between the two nodes is used to represent that it is predicted, based on the historical interaction records, that the two nodes are able to generate an interaction record in the future, a weight of the connection edge between the two nodes is determined through a prediction probability, and the prediction probability is used to represent a probability that the two nodes may generate an interaction record in the future.

20. The device of claim 18, wherein the prediction probability corresponding to the two nodes is determined by instructions causing the device to:
obtain interaction data between the two nodes within preset time; and
determine the prediction probability corresponding to the two nodes by using a pre-trained probability prediction model based on the interaction data.
